(19) United States
(12) Patent Application Publication
(10) Pub. No.: US 2004/0211808 A1
(43) Pub. Date: Oct. 28, 2004

(54) Hand-held power tool

(76) Inventors: Ulrich Rosenbaum, Wangs (CH); Walter Odoni, Planken (LI); Gerhard Ehmig, Rankweil (AT)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/761,609

(22) Filed: Jan. 21, 2004

(30) Foreign Application Priority Data
Jan. 21, 2003 (DE) 103 02 027.6

(51) Int. Cl. B25C 1/14

(52) U.S. Cl. 227/10

(57) ABSTRACT

A hand-held power tool includes a housing (11) in which an energy-driven operational mechanism (12, 13, 14, 15) is located, and at least one latent heat accumulator (20) arranged on the power tool.

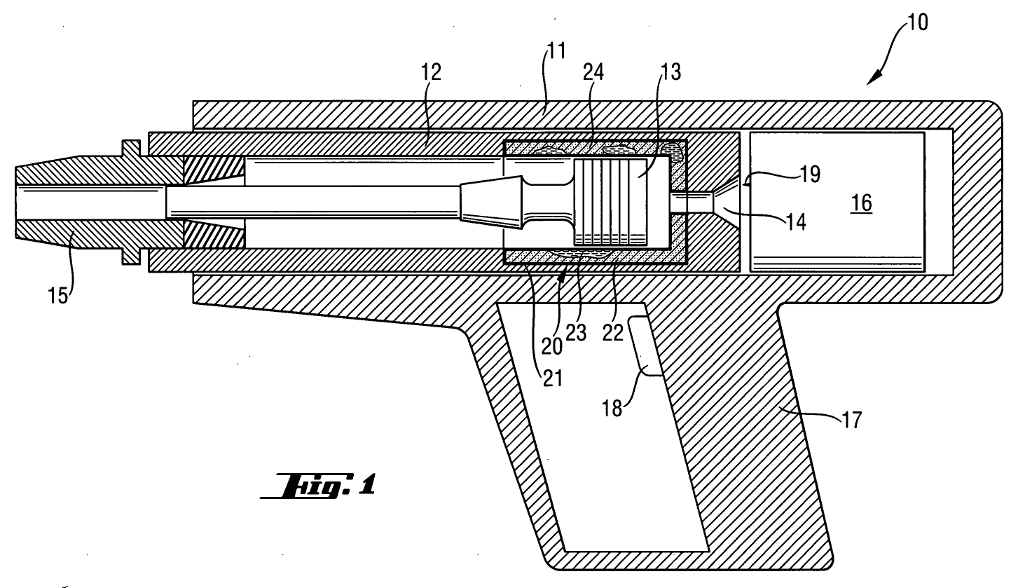

### BACKGROUND OF THE INVENTION

1. Field of the Invention

The present invention relates to a hand-held power tool, in particular, setting tool including a housing and an energy-driven operational mechanism located in the housing.

2. Description of the Prior Art

The hand-held power tools of the type described above are, e.g., driven with solid, liquid or gaseous fuels or with a compressed air. In the combustion-driven power or setting tool, the drive piston is driven by expandable combustion gases for driving a fastening element in the constructional component.

The power tools of the type discussed above can also be formed as hammer drills, percussion drilling tools, chisel tools, drills, mechanical picks, screw-in tools, grinding tools, circular, chain and compass saws.

The above-mentioned power tools, such as setting tools or electrically-driven hand-held tools generate a large amount of heat which leads to an undesirable expansion of separate components, melting of plastic components and the cable insulation.

Therefore, many hand-held power tools are provided with cooling devices which actively cool the tool as long as they operate.

European Patent EP-0 727 285 B1 discloses a setting tool including a ventilator for cooling and rinsing the combustion chamber of the tool.

German Publication DE-0S 21 56 812 discloses an electrically driven hand-held tool in which a ventilator for cooling the tool is arranged on the rotor shaft of the motor for driving the operational mechanism.

The drawback of a motor-driven ventilator cooling consists in generation of additional noise. Another drawback consists in that the ventilator is turned off at the end of an operational cycle. A greater portion of the thermal energy remains in the tool after switching off the motor, without the removal of the residual thermal energy by further positive cooling. As a result, some regions of the power tool remain heated after an operational cycle when the heat is released in the environment by a natural convection of sensitive components.

Accordingly, the object of the present invention is to provide a hand-held power tool in which the drawbacks of the prior art tools are eliminated, and which would have a most possible uniform maximal operational temperature within an operational cycle.

### SUMMARY OF THE INVENTION

This an other objects of the present invention, which will become apparent hereinafter, are achieved by arranging on the power tool at least one latent heat accumulator. The latent heat accumulator advantageously buffers the heat generated in the power tool during its operation at a temperature which depends on the type of the latent heat accumulator and, thereby, prevents overheating of the power tool during the operational cycle. The release of the heat accumulated by the latent heat accumulator in the environment takes places continuously after the end of an operational cycle, without the buffer temperature (melting temperature, phase conversion temperature of the latent heat storable material) being exceeded.

The temperature of the latent heat accumulator increases linear with a further uniform heating. When the temperature is increased to the phase conversion (melting) temperature of the latent heat storable material, the power tool remains at that temperature until, with a solid latent heat storable material, the solid phase is completely converted into the liquid phase. This method of controlling the temperature limits the temperature of the tool to the temperature of the latent heat storable material that prevents the power tool from being heated above the limiting temperature. With an ideal design (volume, type of the material) of the latent heat accumulator, complete melting of the latent heat storable material never takes place.

With sodium acetate-trihydrate being used as a latent heat storable material, the phase-transition or the melting temperature is 58° C.±3°. An advantage of sodium acetate as a latent heat storable material consists in its high heat-absorbing capacity of the thermal energy (>50 kWh/m³) in the phase-transition region from the solid phase to the liquid phase, which provides for a long operational cycle.

With paraffins, which likewise can be used as latent heat storable materials, the melting temperature lies in a range from about 3 to 100° C. The paraffins are likewise characterized by a high capacity to absorb thermal energy. A further advantage of the paraffins consist in that they are inert against almost all materials, i.e., they do not react chemically essentially with other materials.

It is also advantageous to use salts and hydrated salts having a melting point between 20 to 160° C. and having a good capacity to absorb thermal energy in the region of their phase transition from solid phase to liquid phase. These salts are as inexpensive as the paraffins and sodium acetate.

The latent heat accumulator is advantageously arranged in the region of the operational mechanism in the setting tools and/or in the region of the combustion chamber of the setting tool, or in the region of an electrical drive of the power tool. With such an arrangement, the generated heat is buffered directly at a location where it is generated before it can damage the sensitive parts.

The latent heat accumulator can be further arranged in the region of or adjacent to heat-sensitive components, such as cable strands, electronic components, thermally wearable mechanical components, etc. The latent heat accumulator prevents damage of these components due to its absorption of heat.

Advantageously, the latent heat accumulator has a medium-proof lockable chamber in which the latent heat storable medium of the accumulator is located.

The novel features of the present invention, which are considered as characteristic for the invention, are set forth in the appended claims. The invention itself, however both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

Single FIGURE of the drawings shows a cross-sectional view of a power tool according to the present invention formed as a setting tool.

### DETAILED DESCRIPTION OF THE PREFERRED EMBODIMENT

A power tool according to the present invention, which is shown in the drawings, is formed as a powder charge-operated setting tool and is shown in its

### DETAILED DESCRIPTION OF THE PREFERRED EMBODIMENT

A power tool according to the present invention, which is shown in the drawings, is formed as a powder charge-operated setting tool and is shown in its initial or off position. The setting tool 10 has a one or multi-piece housing 11 in which a setting mechanism is located. The setting mechanism drives a fastening element, such as nail, bolt, etc. in a constructional component (not shown) when the setting tool is pressed with its bolt guide 15 against a constructional component and is actuated.

The setting mechanism includes, among other, a cartridge chamber 14 for receiving a propellant, a piston guide 12, a setting or drive piston 13 displaceably arranged in the piston guide 12, and the bolt guide 15 in which a fastening element can be displaced. The bolt guide 15 adjoins, in the setting direction, the piston guide 12, with the piston rod of the piston 13 driving a fastening element located in the bolt guide 15 into a constructional component when the setting tool is pressed against the constructional component.

The setting tool 10 is driven with solid propellants (not shown) which combust upon being ignited with an ignition peg 19 of an ignition device 16. A propellant is ignited when a switch 18, which is arranged on the handle of the setting tool, is actuated.

In the rear region of the piston guide 12, there is arranged a latent heat accumulator 20 that includes a chamber 21. A latent heat storable material 22 is located in the chamber 21. In the discussed embodiment, a sodium acetate (CH₃CO₂Na+3H₂O) is used as the latent heat storable material.

The setting tool 10, which is shown in the drawing, has already effected a setting process and, therefore, thermal energy has already been introduced in the region of the cartridge chamber 14 and the rear region of the piston guide 12. This thermal energy heated the latent heat accumulator 20 and located therein, latent heat storable material 22 to the melting point. As a result, the latent heat storable material 22 has already been partially converted from a solid phase 24 into a liquid phase 23. Thereby, the temperature of the power tool 10 has been brought to the level of the melting temperature of the sodium acetate.

Though the present invention was shown and described with references to the preferred embodiments, such are merely illustrative of the present invention and are not to be construed as a limitation thereof, and various modifications to the present invention will be apparent to those skilled in the art. It is, therefore, not intended that the present invention be limited to the disclosed embodiments or details thereof, and the present invention includes all of variations and/or alternative embodiments within the spirit and scope of the present invention as defined by the appended claims.

What is claimed is:

1. A hand-held power tool, comprising:
a housing (11);
an energy-driven operational mechanism (12, 13, 14, 15) located in the housing; and
at least one latent heat accumulator (20) arranged on the power tool (10).

2. A hand-held power tool according to claim 1, wherein the latent heat accumulator (20) is arranged in a region of the operational mechanism.

3. A hand-held power tool according to claim 1, wherein the latent heat accumulator (20) is arranged adjacent to heat-sensitive components of the power tool (10).

4. A hand-held power tool according to claim 1, wherein the latent heat accumulator comprises a chamber (21) and at least one of latent heat storable material (22) and latent heat storable mixture.

5. A hand-held power tool according to claim 4, wherein the at least one of latent heat storable material (22) and latent heat storable mixture is selected from a group consisting of:
paraffin (Cn H₂n+₂)
salts having a melting temperature between 20° and 160° C., and
hydrated salts having a melting temperature between 20° and 160° C.

6. A hand-held power tool according to claim 4, wherein the at least one of latent heat storable material (22) and latent heat storable mixture is sodium acetate (CH₃CO₂Na+3H₂O).
